(19) United States
(12) Patent Application Publication
(10) Pub. No.: US 2019/0199205 A1
(43) Pub. Date: Jun. 27, 2019

(54) QUASI-RESONANT BUCK-BOOST CONVERTER WITH VOLTAGE SHIFTER CONTROL

(71) Applicant: Flex Ltd., Singapore (SG)

(72) Inventors: Zhang Tao, Shenzhen (CN); Keting Wang, Shenzhen (CN)

(73) Assignee: Flex Ltd

(21) Appl. No.: 15/866,239

(22) Filed: Jan. 9, 2018

(30) Foreign Application Priority Data
Dec. 27, 2017 (CN) 201711446433.X

(51) Int. Cl. H02M 1/42; H02M 7/217; H02M 7/06; H02M 1/08; H02M 1/00

(52) U.S. Cl. CPC H02M 1/4241; H02M 7/217; H02M 2001/4291; H02M 1/083; H02M 2001/0058; H02M 7/06

(57) ABSTRACT

The zero voltage switching quasi-resonant PFC buck-boost converter is directed to a circuit and method of operating the circuit that provides improved efficiency, decreased switching losses and operation at higher frequencies as compared to conventional bridgeless PFC buck-boost converter. The zero voltage switching quasi-resonant PFC buck-boost converter includes a buck transistor switch coupled to an input AC voltage source, a PFC transistor switch and a PFC diode coupled to an output voltage bulk capacitor, and a zero crossing detect inductor magnetically coupled to a buck-boost inductor for determining minimum voltage levels at which to turn ON the buck transistor switch and the PFC transistor switch. The zero voltage switching quasi-resonant PFC buck-boost converter with voltage shifter control addresses the problems of conventional bridgeless PFC buck-boost converters by using different voltage modes and zero crossing detection control.

### CROSS-REFERENCE TO RELATED APPLICATION(S)

This application claims priority under 35 U.S.C. § 119(a)-(d) of the Chinese Patent Application No: 201711446433.X, filed Dec. 27, 2017, and titled, “Quasi-Resonant Buck-Boost Converter with Voltage Shifter Control,” which is hereby incorporated by reference in its entirety for all purposes.

### FIELD OF THE INVENTION

The present invention is generally directed to the power converters. More specifically, the present invention is directed to a quasi-resonant buck-boost converter.

### BACKGROUND OF THE INVENTION

Power conversion refers to the conversion of one form of electrical power to another desired form and voltage, for example converting 115 or 230 volt alternating current (AC) supplied by a utility company to a regulated lower voltage direct current (DC) for electronic devices, referred to as AC-to-DC power conversion, or converting.

A switched-mode power supply, switching-mode power supply or SMPS, is a power supply that incorporates a switching regulator. While a linear regulator uses a transistor biased in its active region to specify an output voltage, an SMPS actively switches a transistor between full saturation and full cutoff at a high rate. The resulting rectangular waveform is then passed through a low-pass filter, typically an inductor and capacitor (LC) circuit, to achieve an approximated output voltage. The switch mode power supply uses the high frequency switch, the transistor, with varying duty cycle to maintain the output voltage. The output voltage variations caused by the switching are filtered out by the LC filter.

An SMPS can provide a step-up, step-down or inverted output voltage function. An SMPS converts an input voltage level to another level by storing the input energy temporarily and then releasing the energy to the output at a different voltage. The storage may be in either electromagnetic components, such as inductors and/or transformers, or electrostatic components, such as capacitors.

Advantages of the SMPS over the linear power supply include smaller size, better power efficiency, and lower heat generation. Disadvantages include the fact that SMPSs are generally more complex than linear power supplies, generate high-frequency electrical noise that may need to be carefully suppressed, and have a characteristic ripple voltage at the switching frequency.

The power factor of an AC electric power system is defined as the ratio of the real power to the apparent power, and is a number between 0 and 1. Real power is the capacity of the circuit for performing work in a particular time. Apparent power is the product of the current and voltage of the circuit. Due to energy stored in the load and returned to the source, or due to a non-linear load that distorts the wave shape of the current drawn from the source, the apparent power can be greater than the real power. Low-power-factor loads increase losses in a power distribution system and result in increased energy costs. Power factor correction (PFC) is a technique of counteracting the undesirable effects of electric loads that create a power factor that is less than 1. Power factor correction attempts to adjust the power factor to unity (1.00).

High power applications, and some low power applications, require the converter to draw current from the AC line with a high power factor. Boost converters are commonly used to produce the high power factor input. A bridge rectifier is commonly connected to an input AC voltage for converting the input AC voltage into a full-wave rectified DC voltage before the voltage is stepped-up. However, the rectifying diodes that constitute the bridge rectifier cause considerable conduction loss resulting in power conversion efficiency degradation. As such, conventional PFC boost converters that include a bridge rectifier typically fail to provide sufficient efficiency for high power applications.

PFC boost converters that do not include a bridge rectifier, commonly referred to as bridgeless PFC boost converters, provide improved efficiency and reduced conduction loss compared to similar PFC boost converters having a bridge rectifier. FIG. 1 illustrates a circuit diagram of a conventional bridgeless power factor correction boost converter. In FIG. 1, an inductor L1 is coupled to a first node on an input AC voltage Vin. A transistor switch Q1 is coupled to the inductor L1. An inductor L10 is magnetically coupled to the inductor L1. A diode D1 is coupled to the inductor L1 and to the transistor switch Q1. The diode D1 is coupled to a bulk output capacitor Cout. The output voltage is the voltage across the bulk output capacitor Cout. A load is coupled to the bulk output capacitor Cout. A capacitor C1 is coupled across the input AC voltage Vin and functions as a filter.

The operation of the bridgeless PFC boost converter consists of two distinct operational states. In an ON-state, the transistor switch Q1 is closed (transistor ON) resulting in an increase in the current through the inductor L1. In the ON-state, current flows from the input AC voltage Vin though the transistor switch Q1 and back to the input AC voltage Vin. Current flow through the inductor L1 stores energy in the inductor L1. In an OFF-state, the transistor switch Q1 is open (transistor OFF) and the current flows through the diode D1, the bulk output capacitor Cout and a load connected across the bulk output capacitor Cout. In the OFF-state, the energy stored in the inductor L1 during the ON-state is transferred to the load as well as the bulk output capacitor Cout. When the transistor switch Q1 is turned ON, voltage and energy are supplied to the load by energy stored in the bulk output capacitor Cout during the OFF-state.

PFC boost converters are generally used in wide input voltage range applications, such as 90 VAC to 264 VAC input, and the output voltage is regulated to a higher value than the input voltage in low power applications. In order to decrease switching losses, critical conduction mode (CRM) PFC with quasi-resonant zero crossing detection (ZCD) is generally applied. As applied to the PFC boost converter of FIG. 1, when the transistor switch Q1 is in an OFF-state, the current in the inductor L1 flows free-wheeling through the diode D1 to the bulk output capacitor and connected load. The inductor current value linearly decreases. When the inductor current decreases to zero, the inductor L1 resonates with the junction capacitance of the transistor switch Q1 and the diode D1, this is referred to as “quasi-resonance”, resulting in a resonant inductor current. Zero crossing of the resonant inductor current corresponds to a valley voltage across the junction capacitor of the transistor switch Q1. ZCD of the resonant inductor current is determined by ZCD circuitry coupled to the inductor L10. ZCD circuitry can be circuitry included as part of a control circuit used to control operation of the transistor switch Q1. When zero crossing of the resonant inductor current is detected, the transistor Q1 is turned ON. Switching loss is small due to the low turn-on valley voltage.

However, switching frequency is variable with the input voltage value. Due to the wide input voltage range, the variable switching frequency range is wide. Also, since the output voltage is regulated to a higher value than the input voltage, higher voltage stress components are needed for subsequent power stages connected to the PFC boost converter.

In some wide input voltage range applications, a step-up/step-down converter, also referred to as a buck-boost converter, is used. FIG. 2 illustrates a circuit diagram of a conventional bridgeless PFC buck-boost converter. In FIG. 2, a transistor switch Q2 is coupled to a first node on an input AC voltage Vin. An inductor L2 and a diode D2 are coupled to the transistor switch Q2. The diode D2 is coupled to a bulk output capacitor Cout. The output voltage Vout is the voltage across the bulk output capacitor Cout. A load is coupled to the bulk output capacitor Cout. A capacitor C2 is coupled across the input AC voltage Vin and functions as a filter.

The operation of the bridgeless PFC buck-boost converter consists of two distinct operational states. In an ON-state, the transistor switch Q2 is closed (transistor ON) and the input AC voltage Vin is directly connected to the inductor L2. The current path is from the input AC voltage Vin, through the transistor switch Q2 and the capacitor C2, through the inductor L2 and back to the input AC voltage Vin. This results in accumulating energy in the inductor L2. In the ON-state, energy is supplied to the output load by the bulk output capacitor Cout. In the OFF-state, the transistor switch Q2 is open (transistor OFF) and the inductor L2 is connected to the output load and bulk output capacitor Cout. The current path is from the inductor L2, through the bulk output capacitor Cout and the output load, through the diode D2 and back to the inductor L2. As such, energy is transferred from the inductor L2 to the bulk output capacitor Cout and the output load.

However, use of the PFC buck-boost converter results in a current value that is higher than either a sole step-up converter or a sole step-down converter. Additionally, the PFC buck-boost converter results in high current/voltage stress. For example: voltage stress of the transistor switch Q2 is (Vout+Vin), which is higher than the voltage stress of the transistor Q1 in the PFC boost converter, and the average current of the inductor L2 in CRM is Vout*(1−D)/(2*Lf*fs) is greater than the average current (Vout*(1−D)*D/(2*Lf*fs)) of the inductor in the PFC boost converter, where D is the duty cycle of transistor switch Q1 or transistor switch Q2, Lf is the inductance of the inductor L1 or the inductor L2, and fs is the switching frequency of transistor switch Q1 or transistor switch Q2.

### SUMMARY OF THE INVENTION

Embodiments of the zero voltage switching quasi-resonant PFC buck-boost converter are directed to a circuit and method of operating the circuit that provides improved efficiency, decreased switching losses and operation at higher frequencies as compared to conventional bridgeless PFC buck-boost converter. The zero voltage switching quasi-resonant PFC buck-boost converter includes a buck transistor switch coupled to an input AC voltage source, a PFC transistor switch and a PFC diode coupled to an output voltage bulk capacitor, and a zero crossing detect inductor magnetically coupled to a buck-boost inductor for determining minimum voltage levels at which to turn ON the buck transistor switch and the PFC transistor switch. The zero voltage switching quasi-resonant PFC buck-boost converter with voltage shifter control addresses the problems of conventional bridgeless PFC buck-boost converters by using different voltage modes and zero crossing detection control.

In an aspect, a power factor correction buck-boost converter is disclosed. The power factor correction buck-boost converter comprises a first transistor switch coupled to a first node of an AC voltage source; a first diode comprising a cathode coupled to the first transistor switch; a first inductor coupled to the first transistor and to the cathode of the first diode; a second transistor switch coupled to the first inductor; a second diode comprising an anode coupled to the first inductor and to the second transistor switch; an output capacitor coupled to a cathode of the second diode; a second inductor magnetically coupled to the first inductor; and a controller coupled to control switching of the first transistor switch and the second transistor switch, wherein the controller is further coupled to the second inductor to determine zero crossing detection. In some embodiments, a cathode of the first diode, a first node of the first transistor, and a first node of the first inductor are commonly coupled. In some embodiments, a second node of the first transistor switch is coupled to the first node of the AC voltage source. In some embodiments, a first node of the second transistor switch, a second node of the first inductor, and the anode of the second diode are commonly coupled. In some embodiments, the first transistor switch and the second transistor switch each comprise a metal-oxide-semiconductor field effect transistor. In some embodiments, the controller is configured to determine between a low line mode and a high line mode, wherein the low line mode corresponds to a low voltage of the AV voltage source and the high line mode corresponds to a high voltage of the AV voltage source. In some embodiments, the controller is further configured to turn the first transistor switch constantly ON and to switch the second transistor ON and OFF at a high frequency during the low line mode. In some embodiments, the controller is further configured to turn the second transistor switch constantly OFF and to switch the first transistor ON and OFF at a high frequency during the high line mode. In some embodiments, during the high line mode the first inductor, the first transistor switch, and the second diode function as a buck converter. In some embodiments, during the low line mode the first inductor, the second transistor switch, and the second diode function as boost converter.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates a circuit diagram of a conventional bridgeless power factor correction boost converter.

FIG. 2 illustrates a circuit diagram of a conventional bridgeless power factor correction buck-boost converter.

FIG. 3 illustrates a circuit diagram of a bridgeless power factor correction buck-boost converter with voltage shifter control according to an embodiment.

FIG. 4 illustrates exemplary logic for turning ON and OFF the transistor switches Q3 and Q4 according to the mode of the input line.

FIG. 5 illustrates a schematic logic configuration for controlling the zero voltage switching quasi-resonant PFC buck-boost converter according to some embodiments.

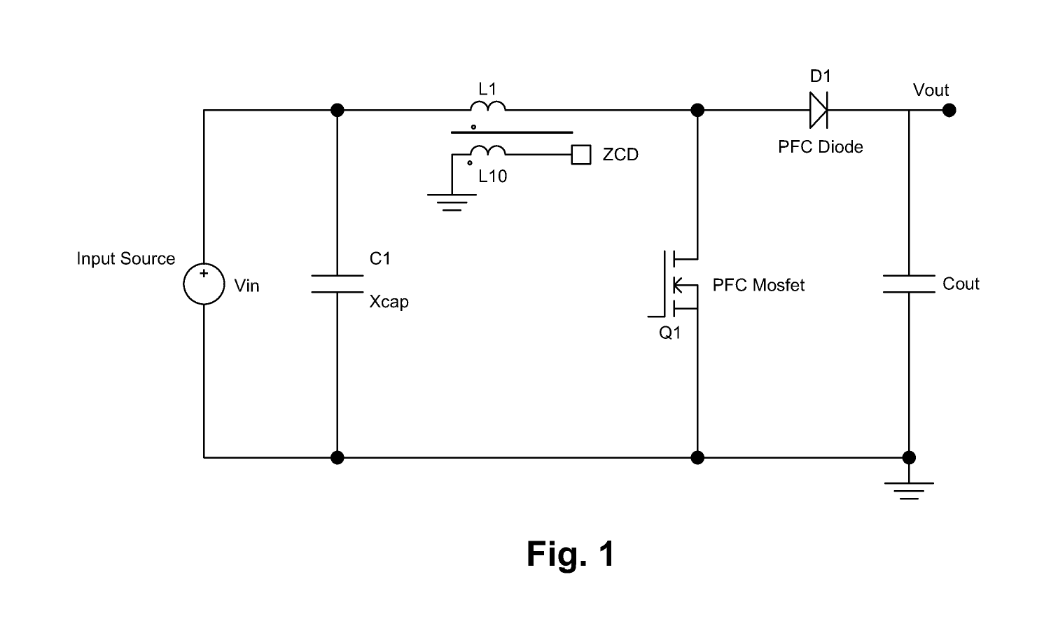

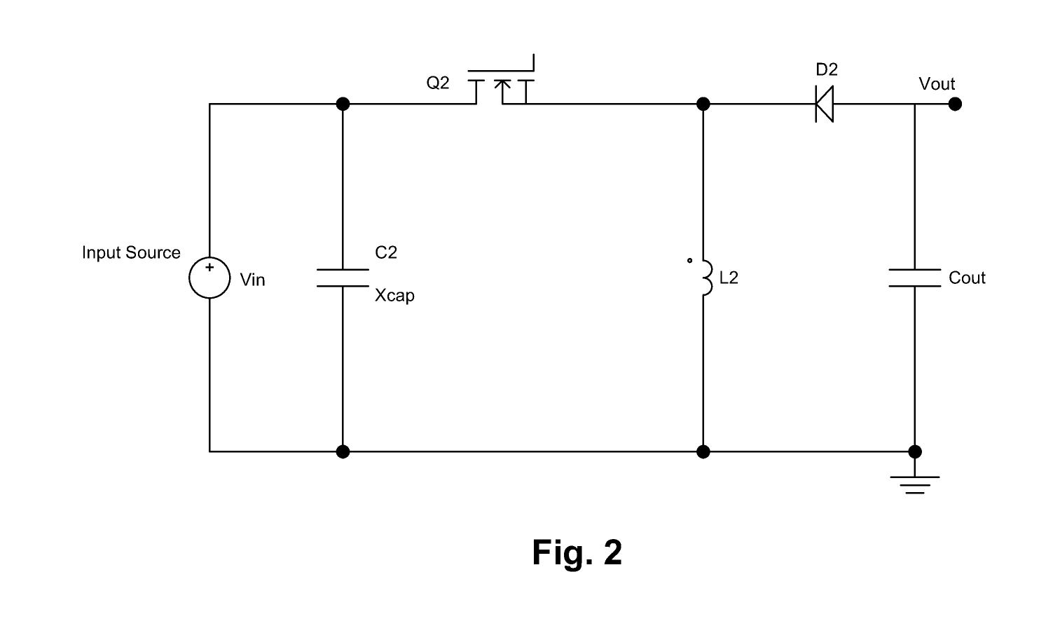

### DETAILED DESCRIPTION OF THE EMBODIMENTS

Embodiments of the present application are directed to a zero voltage switching quasi-resonant PFC buck-boost converter. Those of ordinary skill in the art will realize that the following detailed description of the zero voltage switching quasi-resonant PFC buck-boost converter is illustrative only and is not intended to be in any way limiting. Other embodiments of the zero voltage switching quasi-resonant PFC buck-boost converter will readily suggest themselves to such skilled persons having the benefit of this disclosure.

Reference will now be made in detail to implementations of the zero voltage switching quasi-resonant PFC buck-boost converter as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

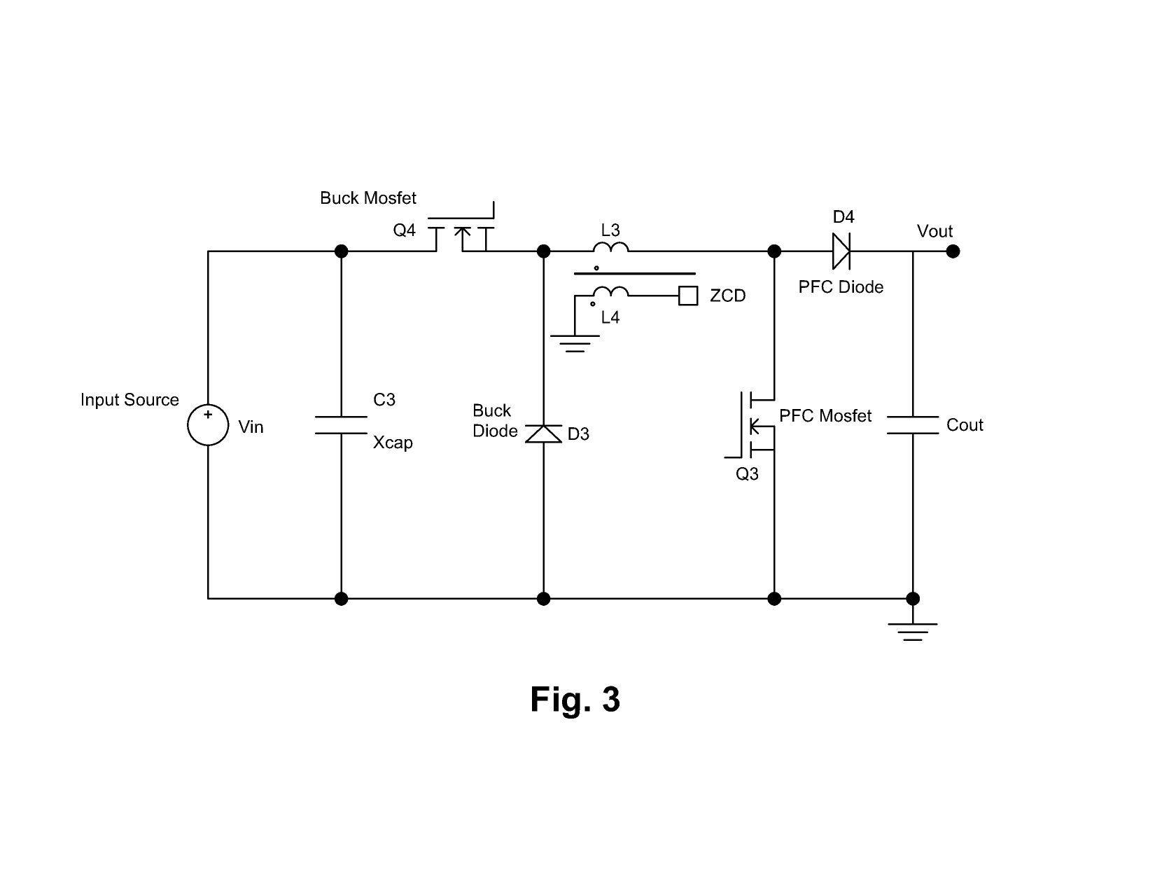

FIG. 3 illustrates a circuit diagram of a zero voltage switching quasi-resonant PFC buck-boost converter according to an embodiment. In FIG. 3, a first node of a capacitor C3 is coupled to a first node on an input AC voltage source, and a first node of a buck transistor switch Q4 is coupled to first node of the input AC voltage source and to the first node of the capacitor C3. A second node of the buck transistor switch Q4 is coupled to a cathode of a diode D3. A first node of a buck-boost inductor L3 is coupled to the second node of the buck transistor switch Q4 and to the cathode of the diode D3. A second node of the buck-boost inductor L3 is coupled to a first node of a PFC transistor switch Q3. An anode of a diode D4 is coupled to the first node of the PFC transistor switch Q3 and to the buck-boost inductor L3. A cathode of the diode D4 is coupled to a first node of an output capacitor Cout and to an output node Vout. A second node of the input AC voltage source, a second node of the capacitor C3, an anode of the diode D3, a second node of the PFC transistor switch Q3 and a second node of the output capacitor Cout are all coupled to ground. An inductor L4 is magnetically coupled to the buck-boost inductor L3. A first nod of the inductor L4 is coupled to ground, and a second node of the inductor L4 is coupled to a zero crossing detection (ZCD) node. In some embodiments, each of the transistor switches Q3 and Q4 are metal-oxide-semiconductor field-effect transistors (MOSFETs). Alternatively, other types of semiconductor transistors can be used.

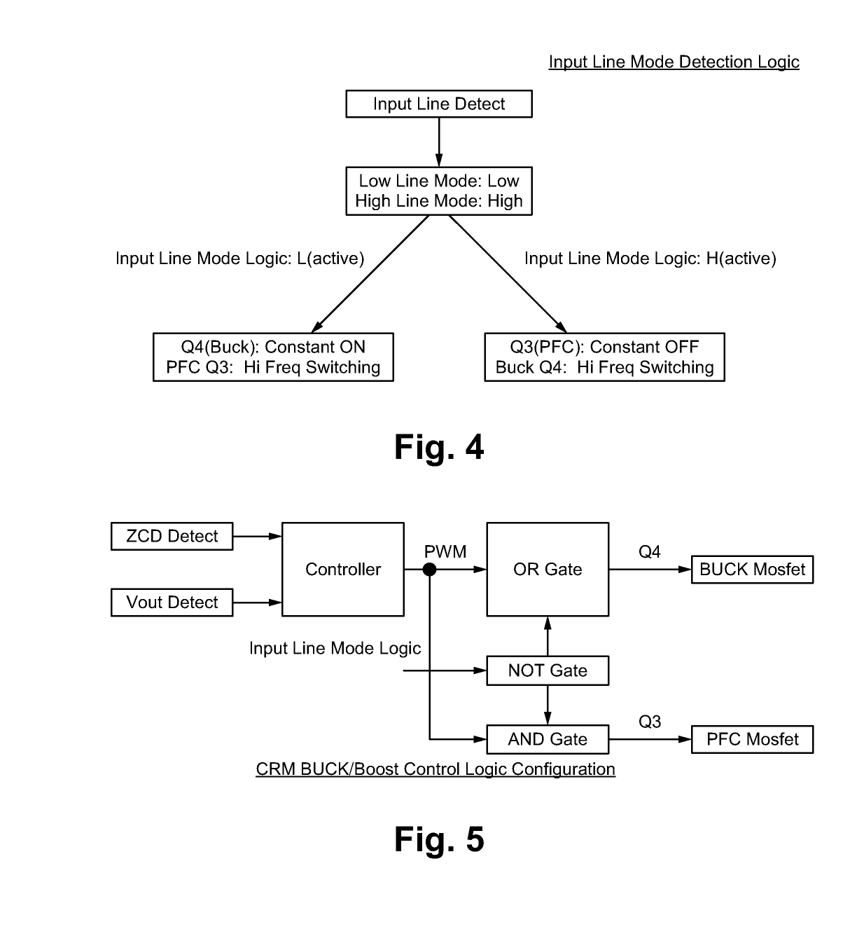

The input AC voltage is either at a high voltage or a low voltage. When the input AC voltage is low, this is considered low line mode. When the input AC voltage is high, this is considered high line voltage. An input line detection circuit is used to sense the input AC voltage and determine if an instantaneous input line voltage corresponds to high voltage or low voltage, and therefore determine whether the converter is operating in the low line mode or the high line mode. In general, if the input line detection circuit senses the input line voltage is lower than the set value (regulated) of the output voltage, then the converter operates in the low line mode. Otherwise, the converter operates in the high line mode. An input line detection logic circuit is used to confirm the input line mode and generate a corresponding input line mode logic signal, as shown in FIG. 4 and applied in FIG. 5. The inductor L4 is magnetically coupled to the buck/boost inductor L3, and the current through the inductor L4 is sensed using ZCD circuitry to detect the inductor current zero crossing. A ZCD signal is fed to a controller (FIG. 5) to insure that transistor switches Q3 or Q4 turn ON at a valley voltage. The output voltage Vout is also sensed and input to the controller to regulate the output voltage Vout to a set regulated value.

In low line mode, the buck transistor switch Q4 is constant ON, and the PFC transistor switch Q3 is switched ON and OFF at a high frequency. In the low line mode, the inductor L3, the PFC transistor switch Q3 and the diode D4 function as a boost converter, and as such the output voltage is higher than the input voltage. When the PFC transistor switch Q3 is ON, current flows from the input AC voltage Vin, through the buck transistor switch Q4, through the inductor L3, through the PFC transistor switch Q3, and back to input source, thereby storing energy in the inductor L3. Energy is delivered to the load by energy previously stored in the bulk output capacitor Cout. When the PFC transistor switch Q3 is OFF, energy stored in the inductor L3 induces current flow from the inductor L3 freewheeling through the diode D4, through the bulk output capacitor Cout and the output load, through the input AC voltage, through the buck transistor switch Q4, and back to the inductor L3. The voltage potential on the left terminal of the inductor L3 is lower than the voltage potential on the right terminal of the inductor L3, and the induced current from the inductor L3 linearly decreases as (Vout-Vin)/Lf. When the induced current decreases to zero, the inductor L3 resonates with the junction capacitance of the PFC transistor switch Q3 and the diode D4, resulting in a resonant inductor current. Zero crossing of the resonant inductor current corresponds to a valley voltage across the junction capacitor of the PFC transistor switch Q3. ZCD of the resonant inductor current is determined by ZCD circuitry coupled to the inductor L4. ZCD circuitry can be circuitry included as part of a control circuit used to control operation of the PFC transistor switch Q3 and the buck transistor switch Q4. When zero crossing of the resonant inductor current is detected, the PFC transistor switch Q3 is turned ON.

In high line mode, the PFC transistor switch Q3 is constant OFF, and the buck transistor switch Q4 is switched ON and OFF at a high frequency. In the high line mode, the inductor L3, the buck transistor switch Q4 and the diode D4 function as a buck converter. When the buck transistor switch Q4 is ON, current flows from the input AC voltage source, through the buck transistor switch Q4, though the inductor L3, through the diode D4, through the bulk output capacitor Cout and the output load, and back to input AC voltage source, thereby storing energy in the inductor L3. When the buck transistor switch Q4 is OFF, energy stored in the inductor L3 induces current flow from the inductor L3, through the diode D4, through the bulk output capacitor Cout and the output load, through the diode D3, and back to the inductor L3. The induced current decreases, and when the induced current decreases to zero, inductor L3 resonates with the junction capacitance of the PFC transistor switch Q3, the buck transistor switch Q4, the diode D3 and the diode D4, resulting in a resonant inductor current. Zero crossing of the resonant inductor current corresponds to a valley voltage across the junction capacitor of the buck transistor switch Q4. When zero crossing of the resonant inductor current is detected, the buck transistor switch Q4 is turned ON.

FIG. 4 illustrates exemplary logic for turning ON and OFF the transistor switches Q3 and Q4 according to the mode of the input line. First, the input line is monitored. Second, it is determined if the detected input line voltage corresponds to a low line mode or a high line mode. If the detected input line voltage corresponds to the low line mode, then the buck transistor switch Q3 is controlled to be constantly ON, and the PFC transistor switch Q4 is controlled to be switched ON and OFF at a high frequency. In some embodiments, high frequency is defined as a frequency between 50 KHz and 1 MHZ. If the detected input line voltage corresponds to the high line mode, then the PFC transistor switch Q4 is controlled to be constantly OFF, and the buck transistor switch Q3 is controlled to be switched ON and OFF at a high frequency.

FIG. 5 illustrates a schematic logic configuration for controlling the zero voltage switching quasi-resonant PFC buck-boost converter according to some embodiments. The logic configuration of FIG. 5 provides schematic implementation of the logic outlined in FIG. 4. The ZCD detect is the voltage at the ZCD node in FIG. 3. The Vout detect is the output voltage Vout in FIG. 3. The ZCD detect voltage and the Vout detect voltage are input to a controller. The controller has electronic processing circuitry including, but not limited to, microprocessing units (MPUs), central processing units (CPUs) or other integrated circuitry used to implement control algorithms. The controller outputs a pulse width modulated (PWM) signal. The PWM signal is input to the OR gate and to the AND gate. The OR gate and the AND gate also receive as input the output from the NOT gate. An input line mode logic signal is input to the NOT gate. The input line mode logic signal is High if the detected input line voltage corresponds to the high line mode, and the input line mode logic signal is Low if the detected input line voltage corresponds to the low line mode, as referenced in regard to FIG. 4. The output of the OR gate is the driving signal for buck transistor switch Q4, and the output of the AND gate is the driving signal for the PFC transistor switch Q3. As previously described, when the input line voltage is high, which corresponds to input line mode logic signal High, the driving signal output from the AND gate drives the PFC transistor switch Q3 to be constantly OFF and the driving signal output from the OR gate drives the buck transistor switch Q4 ON and OFF at a high frequency. When the input line voltage is low, which corresponds to input line mode logic signal Low, the driving signal output from the AND gate drives the PFC transistor switch Q3 ON and OFF at a high frequency and the driving signal output from the OR gate drives the buck transistor switch Q4 to be constantly ON.

By using the different input line modes, for example the low line mode and the high line mode, the working input voltage range becomes narrower for the buck converter (components operating in the high line mode) and boost converter (components operating in the low line mode). Also, for a PFC boost converter the output voltage is higher than the input voltage due to Vout=Vin/(1−Don), which results in Don=1−Vin/Vout. As such, the wider the input voltage range, the wider is the range of duty cycle Don. Additionally, application of quasi resonant technology, for example turning ON transistor switches Q3 and Q4 at valley voltages, results in decreased switching losses, improved efficiency, and enables switching operation at higher frequencies.

The present application has been described in terms of specific embodiments incorporating details to facilitate the understanding of the principles of construction and operation of the zero voltage switching quasi-resonant PFC buck-boost converter. Many of the components shown and described in the various figures can be interchanged to achieve the results necessary, and this description should be read to encompass such interchange as well. As such, references herein to specific embodiments and details thereof are not intended to limit the scope of the claims appended hereto. It will be apparent to those skilled in the art that modifications can be made to the embodiments chosen for illustration without departing from the spirit and scope of the application.

1. A bridgeless power factor correction buck-boost converter comprising:
a first transistor switch coupled to a first node of an AC voltage source;
a first diode comprising a cathode coupled to the first transistor switch;
a first inductor coupled to the first transistor and to the cathode of the first diode;
a second transistor switch coupled to the first inductor;
a second diode comprising an anode coupled to the first inductor and to the second transistor switch;
an output capacitor coupled to a cathode of the second diode;
a second inductor magnetically coupled to the first inductor; and
a controller coupled to control switching of the first transistor switch and the second transistor switch, wherein the controller is further coupled to the second inductor to determine zero crossing detection.

2. The bridgeless power factor correction buck-boost converter of claim 1 wherein a cathode of the first diode, a first node of the first transistor, and a first node of the first inductor are commonly coupled.

3. The bridgeless power factor correction buck-boost converter of claim 2 wherein a second node of the first transistor switch is coupled to the first node of the AC voltage source.

4. The bridgeless power factor correction buck-boost converter of claim 3 wherein a first node of the second transistor switch, a second node of the first inductor, and the anode of the second diode are commonly coupled.

5. The bridgeless power factor correction buck-boost converter of claim 1 wherein the first transistor switch and the second transistor switch each comprise a metal-oxide-semiconductor field effect transistor.

6. The bridgeless power factor correction buck-boost converter of claim 1 wherein the controller is configured to determine between a low line mode and a high line mode, wherein the low line mode corresponds to a low voltage of the AV voltage source and the high line mode corresponds to a high voltage of the AV voltage source.

7. The bridgeless power factor correction buck-boost converter of claim 6 wherein the controller is further configured to turn the first transistor switch constantly ON and to switch the second transistor ON and OFF at a high frequency during the low line mode.

8. The bridgeless power factor correction buck-boost converter of claim 7 wherein the controller is further configured to turn the second transistor switch constantly OFF and to switch the first transistor ON and OFF at a high frequency during the high line mode.

9. The bridgeless power factor correction buck-boost converter of claim 8 wherein during the high line mode the first inductor, the first transistor switch, and the second diode function as a buck converter.

10. The bridgeless power factor correction buck-boost converter of claim 7 wherein during the low line mode the first inductor, the second transistor switch, and the second diode function as boost converter.
